(19) United States
(12) Patent Application Publication
(10) Pub. No.: US 2026/0303615 A1
(43) Pub. Date: Oct. 1, 2026

(54) GRAPH-BASED AND MACHINE-LEARNING TECHNIQUES FOR EVENT CLUSTERING AND THREAT DETECTION

(71) Applicant: Oracle International Corporation, Redwood Shores, CA (US)

(72) Inventors: Yuting Sun, Bellevue, WA (US); Madhav Ashok Kelkar, Leander, TX (US); Maria Vlachopoulou, Bellevue, WA (US); Ramakrishna Raju Uppalapati, San Jose, CA (US); Vardhaman Parasmal Modi, San Jose, CA (US); George Steven Lin, Bellevue, WA (US)

(73) Assignee: Oracle International Corporation, Redwood Shores, CA (US)

(21) Appl. No.: 19/090,184

(22) Filed: Mar. 25, 2025

(51) Int. Cl. H04L 9/40; G06F 18/2321

(52) U.S. Cl. CPC H04L 63/1416; G06F 18/2321

(57) ABSTRACT

Techniques discussed herein relate to a cloud-based threat detection framework that processes detected events using a hybrid graph-based and machine-learning approach. A computing system receives a feature vector associated with a detected event, including a strong entity indicator and a weak entity indicator. The strong entity indicator is processed by a graph model to generate a graph label, which, along with the weak entity indicator, is processed by a machine-learning clustering model to obtain a cluster label for the event. A risk score is determined based on the cluster label, quantifying the event's severity and likelihood of being a threat. A notification message is generated based on the risk score and sent to a user interface for further action. This cloud-based service enables dynamic correlation of events, reduces false positives, and provides actionable insights for efficient threat detection in real-time environments.

### BACKGROUND

In the field of cybersecurity, identifying and responding to security threats is critical to maintaining the integrity of systems and protecting sensitive information. Traditional approaches to threat detection frequently rely on predefined rules or static correlation methods to identify suspicious activity. These systems are designed to detect known patterns of behavior, but their reliance on fixed rules makes them ill-equipped to address the complexity and unpredictability of modern cyberattacks. As attackers evolve their tactics, traditional systems often fail to recognize novel threats or multi-stage attacks that fall outside predefined parameters.

The growing volume and complexity of data within modern information technology (IT) environments further strain existing solutions. Security monitoring systems often produce an overwhelming number of alerts, many of which are false positives or lack sufficient context to prioritize effectively. This creates a significant burden on security analysts, who must sift through large volumes of data to identify genuine threats. The inability to dynamically correlate seemingly unrelated events across different systems and timeframes exacerbates this challenge, leaving gaps in threat detection that adversaries can exploit.

Additionally, traditional systems struggle to process high-dimensional and high-cardinality data, such as Internet Protocol (IP) addresses, user identifiers, and resource attributes, which are common in large-scale environments. These features often vary widely and require sophisticated techniques to analyze effectively. Legacy methods are typically unable to extract meaningful relationships from such data, limiting their ability to identify complex attack patterns or anomalies. Moreover, many existing systems rely on batch processing models, which delay the detection and response to threats in environments where real-time analysis is essential. These limitations highlight the need for more advanced, adaptive approaches capable of addressing the dynamic and interconnected nature of today's cybersecurity landscape.

### BRIEF SUMMARY

Techniques are provided for processing detected events by leveraging a hybrid approach that integrates graph-based modeling and machine-learning clustering to identify and correlate security threats. Various embodiments are described herein, including methods, systems, non-transitory computer-readable storage media storing programs, code, or instructions executable by one or more processors, and the like. Some embodiments may be implemented by using a computer program product, comprising computer program/instructions which, when executed by a processor, cause the processor to perform any of the methods described in the disclosure.

One or more computer programs can be configured to perform particular operations or actions by virtue of including instructions that, when executed by data processing apparatus, cause the apparatus to perform the actions. One general aspect includes a method. The method also includes accessing, by a computing system, One embodiment is directed to a method for receiving, by a computing system, a feature vector associated with a detected event, the feature vector including a strong entity indicator and a weak entity indicator. The method also includes processing, by a graph model of the computing system, the strong entity indicator to obtain a graph label. The method also includes processing, by a machine-learning clustering model of the computing system, the weak entity indicator and the graph label to obtain a cluster label for the detected event. The method also includes determining, based at least in part on the cluster label, a score associated with the detected event. The method also includes generating, based at least in part on the score, a notification message to be stored or sent to a user interface.

Implementations may include one or more of the following features. The method where the graph model includes one or more disjoint graphs, each graph of the one or more disjoint graphs is associated with a label, and where the processing, by the graph model, of the strong entity indicator to obtain a graph label includes identifying a graph of the one or more disjoint graphs associated with the strong entity indicator; and identifying a label associated with the graph. The feature vector may be a first feature vector, and the method may further include identifying, based at least in part on the cluster label, a first cluster of feature vector; and determining a second cluster that is a subset of the first cluster, where each second feature vector of the second cluster satisfies a condition that a distance between the second feature vector and the first feature vector is less than a distance threshold. The method may further include: receiving a record associated with the detected event; and processing the record to obtain the feature vector. The method, where the feature vector is a first feature vector, and the method further includes: identifying a cluster including a second feature vector; determining that a common feature exists between the first feature vector and the second feature vector; and clustering the second feature vector with the first feature vector. The method where the feature vector is a first feature vector, and the method further includes: determining, by the graph model, a first graph associated with the first feature vector; determining, by the graph model, a second graph associated with a second feature vector; and determining whether the first graph and the second graph are disjoint. The method, where determining whether the first graph and the second graph are disjoint includes determining that the first graph and the second graph are not disjoint, and the method further includes clustering the first feature vector and the second feature vector in a same cluster.

In various embodiments, a system is provided that includes one or more data processors and a non-transitory computer readable medium containing instructions which, when executed on the one or more data processors, cause the one or more data processors to perform part or all of one or more methods disclosed herein.

In various embodiments, a non-transitory computer-readable medium, storing computer-executable instructions which, when executed by one or more processors, cause the one or more processors of a computer system to perform one or more methods disclosed herein.

In various embodiments, a computer-program product, comprising computer programs/instructions which, when executed by a processor, causes the processor to perform any of the methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

FIG. 1 illustrates a block diagram illustrating an example of a cloud computing environment for implementing threat detection framework, according to at least one embodiment.

FIG. 2 is a block diagram illustrating an example threat detection service for implementing the threat detection framework, according to at least one embodiment.

FIG. 3 illustrates an example use block diagram of graph-based feature extraction, according to at least one embodiment.

FIG. 4 illustrates a block diagram for post validation operations, according to at least one embodiment.

FIG. 5 illustrates a diagram of an example of merging clusters and forming a merged cluster, according to at least one embodiment.

FIG. 6 illustrates another diagram of an example of filtering based on similarity distance, according to at least one embodiment.

FIG. 7 illustrating a flowchart of an example method for implementing the threat detection framework, in accordance with at least one embodiment.

FIG. 8 is a block diagram illustrating one pattern for implementing a cloud infrastructure as a service system, according to at least one embodiment.

FIG. 9 is a block diagram illustrating another pattern for implementing a cloud infrastructure as a service system, according to at least one embodiment.

FIG. 10 is a block diagram illustrating another pattern for implementing a cloud infrastructure as a service system, according to at least one embodiment.

FIG. 11 is a block diagram illustrating another pattern for implementing a cloud infrastructure as a service system, according to at least one embodiment.

FIG. 12 is a block diagram illustrating an example computer system, according to at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

### INTRODUCTION

The threat detection framework operates as a cloud-based service designed to process detected events and determine their threat levels by leveraging a hybrid approach that integrates graph-based modeling and machine-learning clustering. The framework receives feature vectors associated with detected events, where each feature vector includes a strong entity indicator and a weak entity indicator. Strong entities, which represent robust and deterministic data points such as unique resource identifiers or impacted resource IDs, are processed by a graph model to generate graph labels. These graph labels are used to represent relationships between entities, uncovering both direct and indirect associations within a disjoint graph structure. Weak entities, which include more dynamic and context-sensitive features, are combined with the graph labels and processed by a machine-learning clustering model to generate cluster labels. These cluster labels are then used to determine a score for each detected event, indicating the level of risk or severity associated with the event.

The framework is implemented as a real-time streaming service within a cloud system, capable of dynamically ingesting and processing incoming event data while performing periodic training with historical data. It consists of distributed components, including the graph model for deterministic correlation, the machine-learning clustering model for probabilistic analysis, and a post validation module to refine clustering results and filter out false positives. Post validation steps employ statistical similarity measures and domain-specific rules to re-evaluate cluster assignments, ensuring high accuracy and robustness. The framework is capable of reducing alert volume by correlating related events into high-level clusters, assigning threat scores, and generating notification messages for events that exceed a specified risk threshold. By dynamically correlating events and adapting to evolving threat patterns, this framework provides an efficient and scalable solution for real-time threat detection in cloud environments.

The described threat detection framework addresses several challenges inherent in traditional threat detection systems, particularly in handling the growing complexity and volume of security data in modern cloud environments. Legacy systems often rely on predefined rules and static correlation methods, which are limited in their ability to detect novel or multi-stage attacks that deviate from established patterns. This gap leaves organizations vulnerable to complex, evolving threats that can exploit the fragmented nature of traditional detection systems. Additionally, these systems generate overwhelming volumes of alerts, many of which are false positives or lack sufficient context to prioritize effectively. This creates “alert fatigue” for security analysts, who must manually sift through large numbers of alerts to identify genuine threats, increasing response times and operational burdens.

Embodiments described herein address these and other problems, individually and collectively.

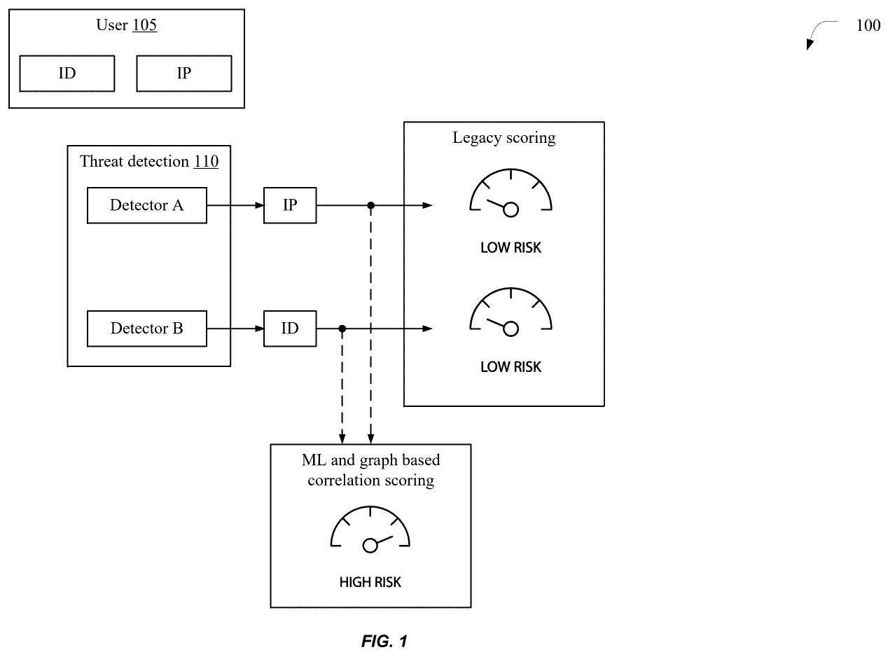

FIG. 1 illustrates a block diagram illustrating an example of a cloud computing environment 100 for implementing threat detection framework, according to at least one embodiment. The environment 100 may include a threat detection service 110 to implement the threat detection framework.

Threat detection 110 may be equipped with multiple detectors, each tailored to identify specific types of suspicious behavior or anomalies within the system. For instance, Detector A is configured to monitor IP address-related activities, such as failed login attempts, unusual geographic access, or high-frequency requests. Detector B, on the other hand, may focus on user identifiers (IDs), such as monitoring unauthorized access to sensitive resources, unexpected privilege escalations, or unusual patterns of user activity. In some embodiments, these detectors may operate independently, generating alerts based on predefined rules or thresholds for identifying suspicious behavior. Each event detected by these detectors may be assigned an initial risk score based on its perceived severity and likelihood of being malicious.

In legacy threat detection systems, the outputs of these detectors are treated as separate and unrelated events. For example, if Detector A flags a low-risk event associated with an IP address linked to a user 105, such as an isolated failed login attempt, and Detector B identifies another low-risk event associated with the ID of the user 105, such as an unusual access request, the system would process these events independently. Each event would be assigned a low-risk score and generate a separate alert. This approach fails to recognize any potential connection between the two events, leaving security analysts with fragmented and siloed information. As a result, the true nature of the threat may go unnoticed, and the underlying risk associated with User 105 remains underestimated.

In contrast, the graph-based and machine-learning correlation approach significantly enhances the threat detection process by dynamically correlating events and uncovering relationships between them. In the same scenario, the framework may identify that both the IP address and ID flagged by Detectors A and B are associated with the user 105. By analyzing these connections, the system recognizes that the two low-risk events, when considered together, may indicate a coordinated or escalating attack targeting User 105. For instance, the failed login attempt from a suspicious IP address could be the precursor to the unusual access request flagged by Detector B. Rather than treating these as independent events, the framework consolidates them into a single high-risk incident, assigning a higher risk score based on their combined significance. This holistic view enables faster and more accurate threat detection, allowing security analysts to focus on meaningful incidents and respond more effectively to potential threats.

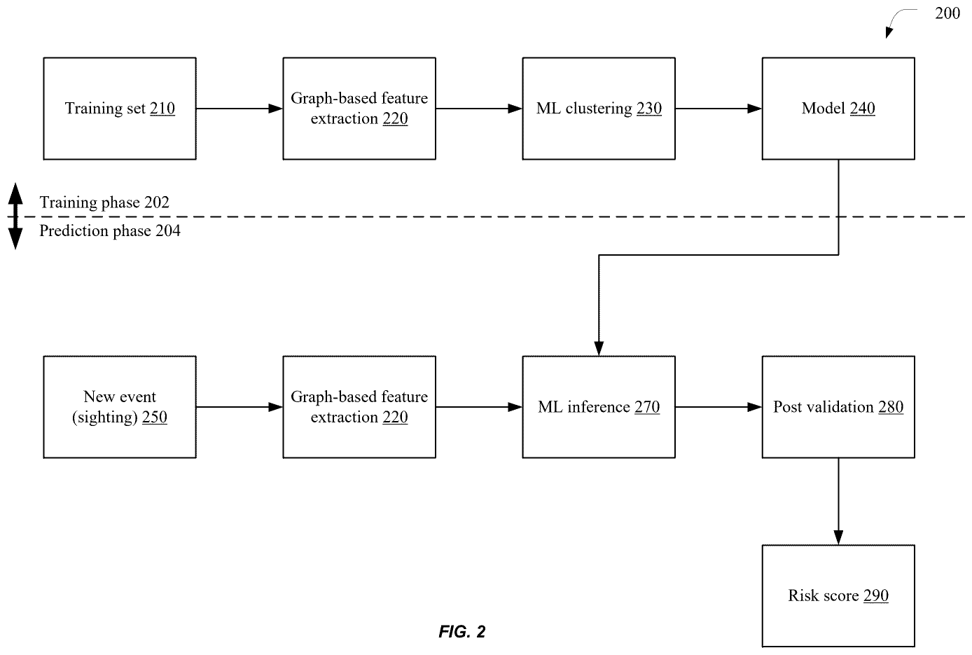

FIG. 2 is a block diagram illustrating an example threat detection service 200 for implementing the threat detection framework, according to at least one embodiment. The implementation of the threat detection framework may involve two interconnected phases: a training phase 202 and a prediction phase 204. In the training phase 202, historical data is used to build and refine models that will later be employed in real-time threat detection. This may involve processing a training set of historical events, extracting features through a graph-based approach, and applying machine-learning clustering techniques to identify patterns and relationships. The output of this phase is a trained model that encapsulates the learned insights and is stored for subsequent use. The prediction phase leverages the trained model to process new events as they are detected in real time. It extracts features from the new events, applies inference using the trained model, and refines the results through post validation. The prediction phase culminates in assigning a risk score to each event, enabling prioritized responses to potential threats. Together, these phases ensure that the framework can learn from past data while adapting dynamically to new inputs.

In the training phase, the process begins with the training set 210. The training set 210 forms the foundation of the training phase, providing a historical dataset that encompasses previously detected events, including their features, labels, and metadata. This dataset is composed of diverse attributes, such as resource IDs, user IDs, IP addresses, timestamps, or impacted resources. The training set's purpose is to offer sufficient data for the framework to learn patterns and relationships between events. For example, if a series of events demonstrates a pattern of failed login attempts followed by privilege escalation activities, the training set captures these details for further processing. The quality and comprehensiveness of the training set are critical, as they directly influence the accuracy and robustness of the resulting model. This dataset may serve as the raw input for subsequent steps in the training phase.

A graph-based feature extraction 220 module may process each event in the training set 210 to identify relationships between specific types of features of recorded events in the training set 210. These features may be categorized based on their characteristics and weight in determining relationship between events. Entities (e.g., features) that are deterministic and less prone to variability, such as resource IDs and impacted resource IDs, are referred to as “strong entities.” These entities typically serve as reliable indicators for identifying direct relationships between events. On the other hand, entities that are more context-dependent and dynamic, such as user behaviors or session metadata, are referred to as “weak entities.” These weak entities often provide complementary information but may lack the consistency needed for direct correlation.

The graph-based feature extraction 220 module may analyze strong entities to uncover relationships and patterns within the dataset. It may uses a graph modeling approach, where strong entities are represented as nodes and their relationships are edges in a graph structure. Each node corresponds to a strong entity, while an edge indicates a direct or indirect connection between two entities. For example, if a resource ID in one event matches the impacted resource ID in another, the module constructs a graph to represent this relationship. Connected nodes are grouped into clusters, and a unique graph label is assigned to each cluster to signify its structure and relationships. This approach effectively reduces the complexity and dimensionality of high-cardinality data while preserving meaningful associations.

By uncovering both direct and indirect connections, the graph-based feature extraction 220 module enables the framework to identify patterns that traditional methods might overlook. For instance, indirect relationships, such as a chain of events involving interconnected resources, can be captured and represented in the graph structure. Additionally, the graph model may address challenges like hash collisions and high dimensionality by transforming complex raw data into simplified, structured representations. This ensures that the extracted features are both robust and efficient, forming a solid foundation for subsequent clustering and inference steps.

The machine-learning clustering 230 module takes a graph label from the graph-based features extraction 220 and the weak entities of an event or sighting and applies clustering algorithms to group events into clusters based on their similarity. This step may identify patterns in the data, such as common combinations of attributes or repeated relationships, and groups similar events into clusters. Density-based clustering methods, such as DBSCAN, are particularly well-suited for this task as they handle clusters of arbitrary shapes and detect outliers effectively. For example, events that share similar temporal patterns, geographic locations, or resource associations are likely to be grouped together. The clustering algorithm also generates metadata for each cluster, such as cluster centroids, boundaries, and density thresholds, which are stored in the model 240. This clustering process is critical for defining the structure of the model 240 and enabling the framework to generalize its understanding of event relationships for future predictions.

The model 240 is the final output of the training phase, encapsulating the insights derived from the ML clustering 230 process. It consists of the learned cluster parameters, such as cluster labels, cluster centroids, and distance thresholds, which represent the relationships and patterns observed in the training set. This model serves as the foundation for the prediction phase, enabling real-time inference by matching new events to previously defined clusters. For example, if the model 240 identifies a cluster associated with suspicious login attempts followed by unauthorized access, future events resembling this pattern will be recognized and flagged. The model is stored in the cloud environment and can be periodically updated with new training data to adapt to evolving threat landscapes.

In the prediction phase 204, the process begins with receiving information of a new event 250 (an event may be referred to as a sighting), which may represent a recently detected security incident. This event is processed in real time and may serve as the input for the remaining steps of the prediction phase 204. The event may include attributes similar to those in the training set, such as strong or weak entities, resource IDs, user identifiers, timestamps, and other features. For example, a new event might capture an unusual access attempt from a previously unseen IP address. This event is passed to the graph-based feature extraction 220 module, ensuring consistency in how features are represented across both training and prediction phases.

The graph-based feature extraction 220 module processes the new event to generate graph labels that represent its relationships to other entities. Using the same methodology as in the training phase 202, the module identifies direct and indirect relationships between the event's strong entities and previously observed entities. For example, if the new event's resource ID matches an impacted resource ID from the training set, the module assigns the corresponding graph label to the event. This ensures that the event's relationships are captured and structured in a way that aligns with the training data, enabling seamless integration into the clustering model.

The ML inference module 270 may apply the trained model to the extracted features (e.g., weak entities and graph label) of the new event 250 to determine its cluster membership (e.g., cluster label). This step may involve comparing the event's features to the clusters defined in the model and assigning the event to the most appropriate cluster. For instance, if the new event shares characteristics with a cluster associated with a known attack pattern, it is assigned the corresponding cluster label. The inference process uses metrics such as distance thresholds and similarity scores to ensure accurate cluster assignments. This step enables the framework to generalize its understanding of past events to new incidents, identifying patterns and relationships in real time.

The post validation 280 module may refine the clustering results by re-evaluating cluster assignments and addressing potential inaccuracies. This may involve applying statistical similarity measures and domain-specific rules to verify that the event's cluster membership is consistent with its features. For example, if an event is misclassified due to noise or outliers, post validation 280 can correct its cluster assignment by considering additional contextual information or re-evaluating its distance to other clusters. This step may also identify and remove false positives, ensuring that the final output is accurate and actionable. The post validation 280 process may enhance the robustness of the framework by filtering out noise and refining the clustering results.

Finally, the framework calculates a risk score 290 for the event based on its cluster membership and other relevant factors. The risk score may quantify the severity of the event, taking into account its proximity to high-risk clusters, its graph label, and any additional domain-specific weighting criteria. For example, an event associated with a high-risk cluster, such as one involving unauthorized access to sensitive resources, would receive a higher risk score. This score is used to prioritize the event for further investigation and may trigger a notification or alert to be sent to a user interface. The risk score may enable security analysts to focus on the most critical threats, improving response times and overall security posture.

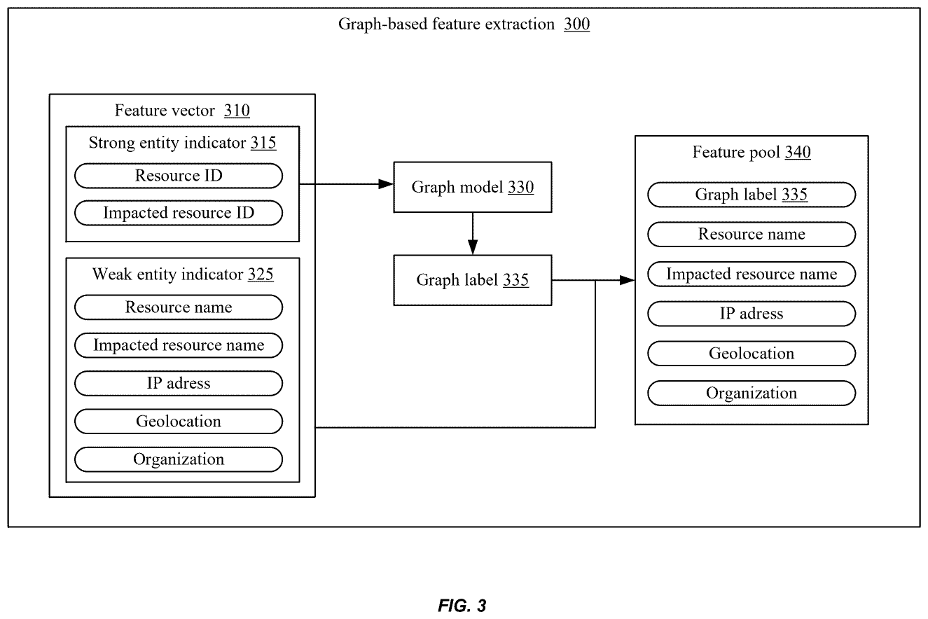

FIG. 3 illustrates an example use block diagram of graph-based feature extraction 300, according to at least one embodiment. The graph-based feature extraction 300 is a fundamental component of the threat detection framework that processes a feature vector 310 to uncover relationships between the new event and past sightings or events and may generate structured representations for further analysis.

The feature vector 310 may include two main categories of features: a strong entity indicator 315 and a weak entity indicator 325, each of which may include one or more attributes. The strong entity indicator 315 may consist of deterministic and high-confidence features, such as resource IDs and impacted resource IDs, which provide a reliable basis for identifying direct relationships between events. These strong entities can be either managed internally based on domain knowledge or customized by external customers. In contrast, the weak entity indicator 325 may include more dynamic and context-sensitive features, such as resource names, impacted resource names, IP addresses, geolocation, and organizational information. While strong entities focus on establishing deterministic relationships, weak entities provide additional context to enrich subsequent analysis.

At the core of the graph-based feature extraction 300 is the graph model 330, which processes the strong entity indicator 315 to generate a graph label 335. The graph model 330 represents relationships between strong entities of events using a graph structure, where nodes correspond to strong entities, and edges represent direct or indirect connections between them. For example, if a resource ID in one event matches the impacted resource ID in another event, an edge is created between the corresponding nodes. This relationship is further expanded to include indirect connections, where multiple events form a chain of relationships. The graph model 330 may consolidate these connections into a single, unified graph label 335 that identifies the cluster of interconnected features or attributes of different events. The label 335 may provide a compact representation of the relationships within the graph, significantly reducing the complexity of the data while retaining its essential structure.

The following example shows how the graph model 330 operates. Consider four events with the following relationships: Event 1 where Resource A impacts Resource A; Event 2 where Resource A impacts Resource B; Event 3 where Resource B impacts Resource C; and Event 4 where Resource C impacts Resource D. The graph model 330 may process these relationships and constructs a graph where nodes represent resources (A, B, C, D), and edges represent the relationships between them. The model identifies that all these resources are interconnected through direct or indirect relationships and assigns them a common graph label, such as “Graph Label 1”. This label may encapsulate the entire relationship chain, allowing the system to treat all these events as part of a cohesive group.

For instance:

| | | ENTITY_2: | Graph |
|---|---|---|---|
| | ENTITY_1: | Impacted | Label |
| Sighting | Resource ID | Resource ID | 335 |
| 1 | A | B | 1 |
| 2 | B | C | 1 |
| 3 | C | D | 1 |

This example shows 3 distinct sightings distinguished by their unique Resource IDs. By applying a graph model based on the entity features ‘Resource ID’ and ‘Impacted Resource ID’, we identify that Sightings 1 and 2 share a relationship: Sighting 1's Impacted Resource ID matches Sighting 2's Resource ID. Similarly, Sighting 2's Impacted Resource ID corresponds to Sighting 3's Resource ID. Consequently, we label all three sightings with the same value=1 as seen in the rightmost column. The graph label 335 may replace the encoded Resource ID and Impacted Resource ID, streamlining feature representation and significantly reducing feature dimensionality for ML clustering.

By grouping related entities under the same graph label 335, the graph model may capture both direct and indirect relationships. For example, while Resource A and Resource D do not have a direct relationship, the model identifies their indirect connection through Resources B and C. This ability to uncover indirect relationships is a key advantage of the graph-based feature extraction process, enabling the framework to identify patterns that traditional methods might miss.

The feature pool 340 is formed by combining the graph label 335 with the features associated with the weak entity indicator 325. The weak entity features, such as resource names, IP addresses, and geolocation, provide additional context to complement the structural information captured by the graph label 335. For instance, if multiple events share a graph label but occur in different geolocations, the weak entity features can help distinguish between localized and distributed threats. Together, the graph label 335 and weak entity features create a comprehensive representation of the event, which serves as the input for downstream clustering and inference operations.

The graph model 330 also addresses challenges such as high cardinality and hash collisions by focusing on strong entities for graph construction. Instead of encoding resource IDs into numerical vectors that may result in collisions, the model directly represents these entities as nodes, preserving their uniqueness and relationships. This approach ensures that the extracted graph labels are both robust and interpretable, providing a solid foundation for subsequent machine-learning clustering and inference steps.

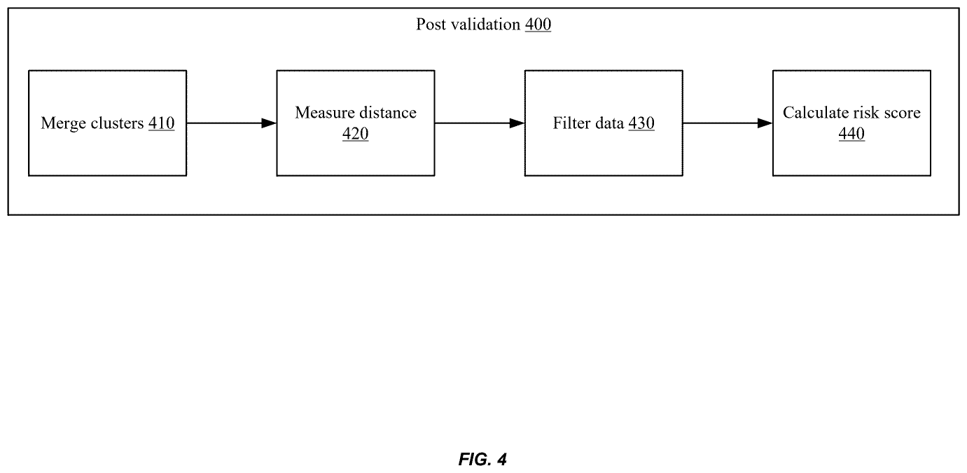

FIG. 4 illustrates a block diagram for post validation 400 operations, according to at least one embodiment. The post validation 400 module is a component of the threat detection framework that refines clustering results and enhances the accuracy of threat assessments. This module operates after the machine-learning clustering process to refine the output, making it both accurate and actionable. The post validation process may consist of four steps: merge clusters 410, measure distance 420, filter data 430, and calculate risk score 440. These steps work together to address inaccuracies, reduce noise, and refine the final risk scores assigned to events to reflect the true nature of the threats The ultimate goal of post validation is to produce high-quality outputs that facilitate effective threat prioritization and response.

The merge clusters 410 step identifies clusters that may have been incorrectly separated during the initial clustering process and combines them into a single cluster if they share significant commonalities. For example, two clusters that share the same cluster label may be merged into one, as they likely represent different aspects of the same underlying threat. This step groups related events together, reducing fragmentation and providing a more holistic view of the threat. By consolidating clusters, this step may reduce the risk of underestimating the severity of an attack due to dispersed event groupings.

The measure distance 420 step evaluates the similarity between events within a cluster to determine their degree of relatedness. This may involve calculating the distance between feature vectors, including both strong and weak entity features, using statistical or geometric metrics. For example, a nearest-neighbors algorithm may be used to measure how closely a new event aligns with existing events in the cluster. If the distance between an event and the core of the cluster exceeds a predefined threshold, it may indicate that the event does not belong to the cluster. This step refines the cluster composition, grouping only closely related events together, thereby improving the precision of the framework.

The filter data 430 step removes events that are misclassified or deemed outliers based on the results of the distance measurement. For instance, events that fall outside the cluster boundaries or have low similarity scores relative to other events in the cluster are excluded from further analysis. This step reduces noise and prevents the inclusion of irrelevant or unrelated data in the final risk assessment. By filtering out such data, the framework ensures that the remaining events within a cluster provide a clear and accurate representation of the threat.

The calculate risk score 440 step is the culmination of the post validation process, where a numerical score is assigned to each event or cluster to quantify the level of threat it poses. The risk score is determined based on multiple factors, including the cluster label, the graph label, proximity to high-risk clusters, and additional domain-specific criteria. For example, if an event is part of a cluster associated with known high-risk activities, such as unauthorized access or data exfiltration, it may receive a higher risk score. The calculation may also account for the relationships identified during graph-based feature extraction, such as the number and type of connections between entities. Additionally, weak entity features, such as geolocation or IP address, may influence the score by providing contextual information about the event's origin or scope.

The risk score may be a weighted combination of various metrics that collectively reflect the severity or likelihood of a threat. For instance, a scoring formula may assign higher weights to factors such as cluster density, the presence of strong entity relationships, or patterns indicative of multi-stage attacks. This ensures that events with greater potential impact or malicious intent are prioritized. The final risk score serves as the basis for generating notifications or alerts, enabling security analysts to focus on the most critical threats. By systematically quantifying risk, the calculate risk score 440 step provides actionable insights that enhance decision-making and improve the overall effectiveness of the threat detection framework.

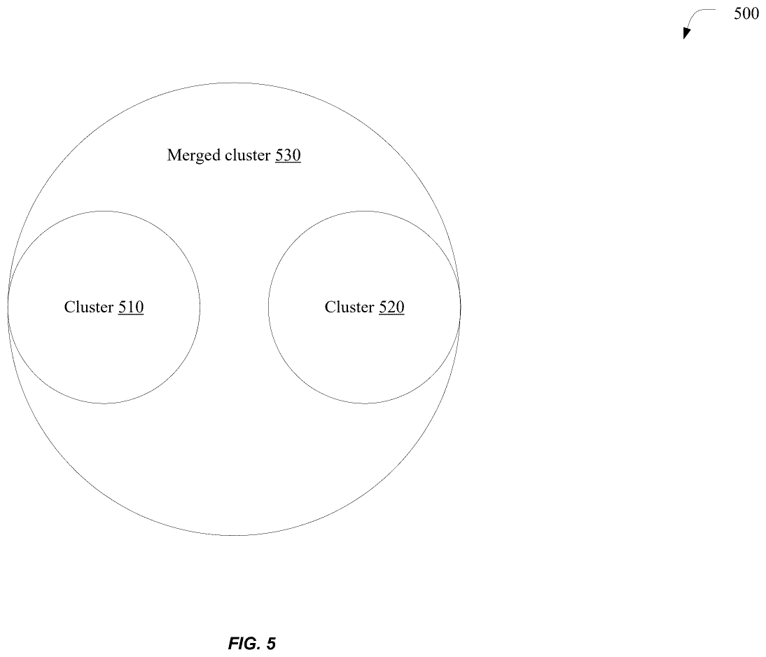

FIG. 5 illustrates a diagram of an example of merging clusters 500 and forming a merged cluster 530, according to at least one embodiment. The merging clusters 500 may be an example of merge clusters 410 step is a post validation 400 process in FIG. 4 that identifies clusters that should be combined due to shared characteristics or overlapping features. This step may address situations where related events may have been incorrectly assigned to separate clusters during the initial clustering process. For instance, consider two clusters, cluster 510 and cluster 520, which are initially treated as distinct but share significant commonalities, such as the same graph label or overlapping strong entities. By analyzing these shared features, the framework determines that the clusters represent different aspects of the same underlying threat and merges them into a single cluster, merged cluster 530. This process may reduce fragmentation, consolidates related events, and provides a more comprehensive view of the threat.

The merging operation may begin by analyzing the characteristics of the clusters being considered. For example, if cluster 510 and cluster 520 share a common graph label generated by the graph-based feature extraction process, it indicates that their strong entities, such as resource IDs or impacted resource IDs, are interconnected. Similarly, if events in both clusters share overlapping weak entities, such as IP addresses or geographic locations, this further supports the conclusion that the clusters are related. The framework evaluates these shared features and combines the clusters into a single, unified representation, merged cluster 530, capturing all the associated events and relationships.

In one example, suppose cluster 510 contains events with resource IDs A and B, while cluster 520 contains events with resource IDs B and C. The shared resource ID B indicates a direct relationship between the two clusters, prompting the framework to merge them into merged cluster 530. This new cluster now includes all events associated with resource IDs A, B, and C, capturing the full chain of relationships and providing a unified view of the threat.

The merging process is particularly useful in scenarios where threats span multiple domains or systems. For instance, one cluster might represent a set of failed login attempts associated with a specific IP address, while another cluster might include unusual access patterns linked to the same user identifier. By merging these clusters, the framework identifies that the two seemingly distinct activities are part of a coordinated attack, such as an account compromise attempt followed by unauthorized access.

The process of merging clusters also may consider domain-specific rules to refine the operation. For example, if a rule specifies that all events within a certain geographic region or organizational boundary should be treated as a single cluster, the framework evaluates whether clusters meet this criterion before merging them. This approach allows for flexibility and adaptability in handling diverse datasets and evolving threat scenarios.

By merging clusters that share significant commonalities, the framework reduces the risk of underestimating the severity of an attack due to fragmented event groupings. The resulting merged cluster 530 provides a more complete and actionable representation of the threat, enabling more accurate risk scoring and prioritization for further investigation. This step contributes to the framework's ability to dynamically adapt to complex and interconnected threat patterns, improving its overall effectiveness in detecting and responding to security incidents.

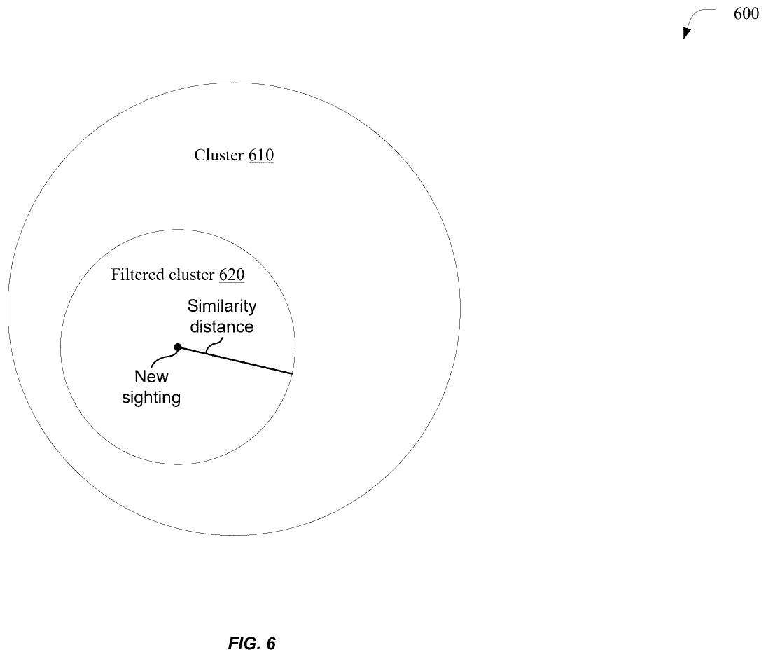

FIG. 6 illustrates another diagram of an example of filtering 600 based on similarity distance, according to at least one embodiment. The filtering 600 may be an example of filter data 430 step in FIG. 4. Filtering 600 may be a refinement process in the post validation phase (e.g., post validation 400 in FIG. 4) that evaluates whether events within a cluster are sufficiently similar to remain part of that cluster and final risk calculation step. The framework may initially assign a new detected event or sighting to cluster 610 based on its feature vector and cluster label determined during machine-learning inference. However, the similarity of this new sighting to the other events in cluster 610 may be re-assessed using a similarity distance. The similarity distance may serve as a measure of how closely the new sighting aligns with the cluster's defining attributes. Events that fail to meet the similarity criteria are filtered out, resulting in a refined grouping referred to as filtered cluster 620. This process not only improves the quality of the cluster but also directly impacts the subsequent risk scoring and classification of the detected event.

The similarity distance is computed by comparing the feature vector of the new sighting to the feature vectors of other data points in the cluster. Statistical or geometric metrics, such as Euclidean distance, cosine similarity, or other distance functions, are used depending on the nature of the feature space. These calculations consider both strong entity features, such as resource IDs and impacted resource IDs, and weak entity features, such as IP addresses, geolocations, and behavioral attributes. The framework may use a predefined similarity distance threshold, which may be configured based on domain-specific rules or dynamically set during model training to adapt to the characteristics of the data. For example, in high-sensitivity clusters, stricter thresholds might be applied to reduce the likelihood of false positives.

Once the similarity distance is calculated, the framework applies it to filter out events that deviate significantly from the cluster's core characteristics. If the similarity distance between a new sighting and the cluster exceeds the predefined threshold, the sighting is excluded from filtered cluster 620, as it is considered an outlier or misclassified data point. For example, if cluster 610 primarily consists of events involving specific resource IDs (A, B, C) and an IP address (67.195.160.76), a new sighting with a resource ID (D) and an IP address (74.125.227.160) might diverge significantly from the cluster's core profile. This sighting would be identified as an outlier and removed from the cluster, leaving filtered cluster 620 with only events that exhibit strong alignment with the cluster's defining attributes.

The impact of filtering may extend beyond refining the cluster composition. By removing outliers, the filtering step may directly influence the calculation of the risk score and the classification of the detected event. The risk score for the new sighting may be determined based on its membership in filtered cluster 620. Events that remain in the refined cluster are more likely to share strong relationships with high-risk patterns or established attack chains, leading to a higher risk score. Conversely, events filtered out are excluded from the risk scoring process, reducing the likelihood of inflating risk scores due to unrelated or noisy data points. This refined scoring process allows the framework to more accurately classify the detected event as low, medium, or high risk, ensuring that resources are allocated appropriately to investigate and mitigate genuine threats.

For example, in the context of a coordinated attack, filtering might remove events that are unrelated to the primary threat, enabling the risk score to more accurately reflect the severity of the attack. If filtered cluster 620 consists of events directly associated with unauthorized access attempts or privilege escalation activities, the risk score for the new sighting would reflect the heightened threat level of these activities. On the other hand, if the new sighting were an outlier with minimal relevance, its exclusion from the cluster would prevent it from contributing to an inflated or misleading risk score.

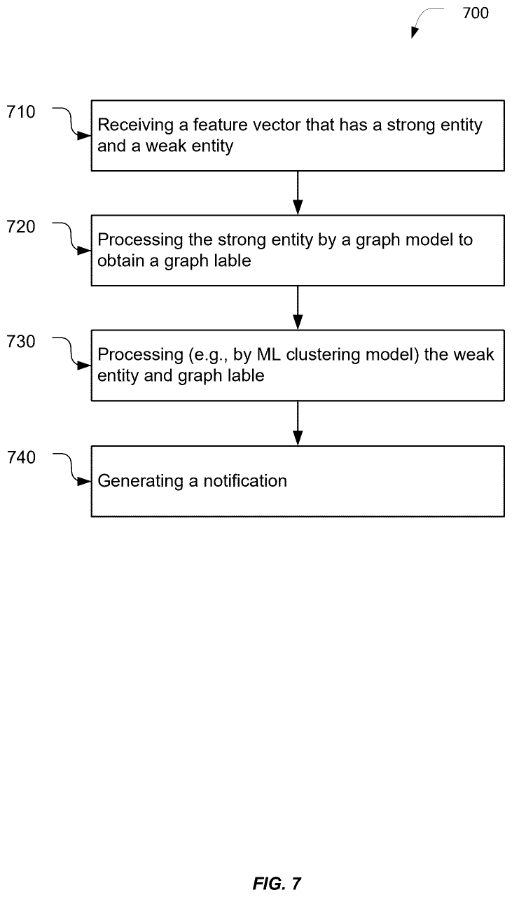

FIG. 7 illustrating a flowchart of an example method 700 for implementing the threat detection framework, in accordance with at least one embodiment. The method 700 may be performed by a cloud-based threat detection service. In some embodiments, the method 700 may include more or fewer steps than the number depicted in FIG. 7. It should be appreciated that the steps of method 700 may be performed in any suitable order or even in parallel with one another.

The method 700 may include, at 710, receiving, by a computing system, a feature vector associated with a detected event, the feature vector including a strong entity indicator and a weak entity indicator. The feature vector may represent the attributes of the detected event, with the strong entity indicator including deterministic features such as resource IDs and impacted resource IDs, which may provide reliable identifiers for establishing direct relationships between entities. The weak entity indicator may include dynamic and context-sensitive features such as resource names, impacted resource names, IP addresses, geolocations, and organizational information. This combination of strong and weak entity indicators may provide a comprehensive representation of the detected event, enabling the system to analyze both high-confidence relationships and contextual data to uncover meaningful patterns.

In some embodiments, the method 700 may further include receiving a record associated with the detected event and processing the record to obtain the feature vector. For example, the computing system may extract attributes such as user activity logs, network traffic data, or system resource metadata from the record to generate the feature vector. This process may convert raw event data into a structured format that can be analyzed in subsequent steps, providing consistency and compatibility with the framework's feature processing modules.

The method 700 may include, at 720, processing, by a graph model of the computing system, the strong entity indicator to obtain a graph label. The graph model may process the strong entity indicator to identify relationships between entities, constructing a graph where nodes represent strong entities and edges represent direct or indirect connections. For example, if a resource ID in one event matches the impacted resource ID in another event, the graph model links the corresponding nodes and assigns a graph label to represent the cluster of interconnected entities. This graph label captures the structural relationships between the entities, reducing data complexity while retaining meaningful patterns for further analysis.

In some embodiments, the graph model may include one or more disjoint graphs, with each graph associated with a label. The processing of the strong entity indicator to obtain a graph label may include identifying a graph associated with the strong entity indicator and identifying a label associated with the graph. For instance, the graph model may analyze multiple disjoint graphs, each representing an independent set of relationships, and assign a specific graph label to the detected event based on its strong entity indicator. This approach enables the framework to efficiently handle high-cardinality data while maintaining clear distinctions between unrelated clusters.

The method 700 may include, at 730, processing, by a machine-learning clustering model of the computing system, the weak entity indicator and the graph label to obtain a cluster label for the detected event. The clustering model may combine the contextual information from the weak entity indicator with the structural relationships represented by the graph label to determine the appropriate cluster for the detected event. The machine-learning model may employ algorithms such as density-based clustering to group similar events, considering attributes like IP addresses, geolocations, and organization names alongside the graph label. The resulting cluster label may indicate the group of related events to which the detected event belongs, providing a basis for further analysis and risk assessment.

In some embodiments, the method 700 may further include identifying, based at least in part on the cluster label, a first cluster of feature vectors and determining a second cluster that is a subset of the first cluster, wherein each second feature vector of the second cluster satisfies a condition that a distance between the second feature vector and the first feature vector is less than a distance threshold. For example, the framework may refine the cluster composition by applying a similarity distance metric, filtering out outliers or misclassified events, and retaining only those events that closely align with the cluster's core attributes.

The method 700 may include, at 740, determining, based at least in part on the cluster label, a score associated with the detected event. The score may quantify the severity or likelihood of the detected event being a threat, based on its membership in the assigned cluster and its proximity to high-risk patterns or attack chains. The scoring process may consider factors such as the density of the cluster, the relationships captured by the graph label, and additional contextual attributes from the weak entity indicator. For example, events associated with high-risk clusters, such as those involving privilege escalation or unauthorized data access, may receive higher scores.

In some embodiments, the score may be calculated by assessing the comprehensive risk associated with the potentially suspicious target associated with the cluster of correlated sightings. For instance, the framework may aggregate the risk levels of all events within the cluster, weighting them based on their relevance and significance, to produce a composite score for the detected event. This approach provides a nuanced assessment of the threat, enabling precise prioritization for further investigation.

The method 700 may include, at 750, generating, based at least in part on the score, a notification message to be stored or sent to a user interface. The notification message may include information about the detected event, such as its assigned risk score, cluster label, and relevant attributes, providing security analysts with actionable insights for threat mitigation. For example, if the risk score exceeds a predefined threshold, the notification may trigger an alert in the user interface, highlighting the event as a high-priority threat that requires immediate attention.

In some embodiments, the notification message may include additional details about the detected event, such as its relationships within the cluster or graph structure, to provide context for the security analyst. For instance, the message may indicate that the event is part of a chain of activities involving multiple resources and geolocations, helping analysts understand the broader context of the threat and formulate an appropriate response.

### Example IaaS Environments

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

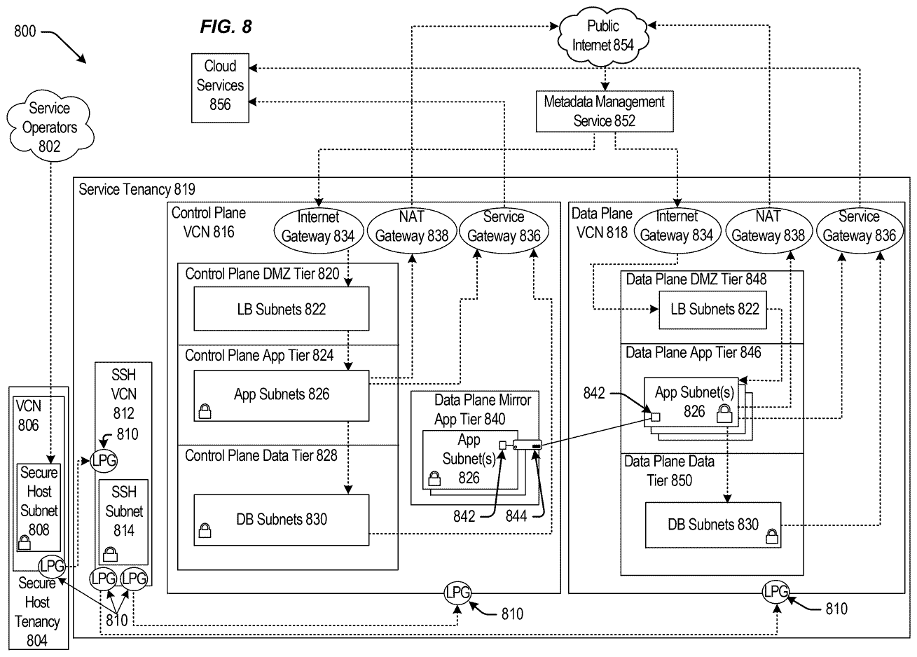

FIG. 8 is a block diagram 800 illustrating an example pattern of an IaaS architecture, according to at least one embodiment. Service operators 802 can be communicatively coupled to a secure host tenancy 804 that can include a virtual cloud network (VCN) 806 and a secure host subnet 808. In some examples, the service operators 802 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 806 and/or the Internet.

The VCN 806 can include a local peering gateway (LPG) 810 that can be communicatively coupled to a secure shell (SSH) VCN 812 via an LPG 810 contained in the SSH VCN 812. The SSH VCN 812 can include an SSH subnet 814, and the SSH VCN 812 can be communicatively coupled to a control plane VCN 816 via the LPG 810 contained in the control plane VCN 816. Also, the SSH VCN 812 can be communicatively coupled to a data plane VCN 818 via an LPG 810. The control plane VCN 816 and the data plane VCN 818 can be contained in a service tenancy 819 that can be owned and/or operated by the IaaS provider.

The control plane VCN 816 can include a control plane demilitarized zone (DMZ) tier 820 that acts as a perimeter network (e.g., portions of a corporate network between the corporate intranet and external networks). The DMZ-based servers may have restricted responsibilities and help keep breaches contained. Additionally, the DMZ tier 820 can include one or more load balancer (LB) subnet(s) 822, a control plane app tier 824 that can include app subnet(s) 826, a control plane data tier 828 that can include database (DB) subnet(s) 830 (e.g., frontend DB subnet(s) and/or backend DB subnet(s)). The LB subnet(s) 822 contained in the control plane DMZ tier 820 can be communicatively coupled to the app subnet(s) 826 contained in the control plane app tier 824 and an Internet gateway 834 that can be contained in the control plane VCN 816, and the app subnet(s) 826 can be communicatively coupled to the DB subnet(s) 830 contained in the control plane data tier 828 and a service gateway 836 and a network address translation (NAT) gateway 838. The control plane VCN 816 can include the service gateway 836 and the NAT gateway 838.

The control plane VCN 816 can include a data plane mirror app tier 840 that can include app subnet(s) 826. The app subnet(s) 826 contained in the data plane mirror app tier 840 can include a virtual network interface controller (VNIC) 842 that can execute a compute instance 844. The compute instance 844 can communicatively couple the app subnet(s) 826 of the data plane mirror app tier 840 to app subnet(s) 826 that can be contained in a data plane app tier 846.

The data plane VCN 818 can include the data plane app tier 846, a data plane DMZ tier 848, and a data plane data tier 850. The data plane DMZ tier 848 can include LB subnet(s) 822 that can be communicatively coupled to the app subnet(s) 826 of the data plane app tier 846 and the Internet gateway 834 of the data plane VCN 818. The app subnet(s) 826 can be communicatively coupled to the service gateway 836 of the data plane VCN 818 and the NAT gateway 838 of the data plane VCN 818. The data plane data tier 850 can also include the DB subnet(s) 830 that can be communicatively coupled to the app subnet(s) 826 of the data plane app tier 846.

The Internet gateway 834 of the control plane VCN 816 and of the data plane VCN 818 can be communicatively coupled to a metadata management service 852 that can be communicatively coupled to public Internet 854. Public Internet 854 can be communicatively coupled to the NAT gateway 838 of the control plane VCN 816 and of the data plane VCN 818. The service gateway 836 of the control plane VCN 816 and of the data plane VCN 818 can be communicatively coupled to cloud services 856. Cloud services 856 may include the threat detection framework using a hybrid graph-based and machine-learning approach according to disclosed embodiments.

In some examples, the service gateway 836 of the control plane VCN 816 or of the data plane VCN 818 can make application programming interface (API) calls to cloud services 856 without going through public Internet 854. The API calls to cloud services 856 from the service gateway 836 can be one-way: the service gateway 836 can make API calls to cloud services 856, and cloud services 856 can send requested data to the service gateway 836. But, cloud services 856 may not initiate API calls to the service gateway 836.

In some examples, the secure host tenancy 804 can be directly connected to the service tenancy 819, which may be otherwise isolated. The secure host subnet 808 can communicate with the SSH subnet 814 through an LPG 810 that may enable two-way communication over an otherwise isolated system. Connecting the secure host subnet 808 to the SSH subnet 814 may give the secure host subnet 808 access to other entities within the service tenancy 819.

The control plane VCN 816 may allow users of the service tenancy 819 to set up or otherwise provision desired resources. Desired resources provisioned in the control plane VCN 816 may be deployed or otherwise used in the data plane VCN 818. In some examples, the control plane VCN 816 can be isolated from the data plane VCN 818, and the data plane mirror app tier 840 of the control plane VCN 816 can communicate with the data plane app tier 846 of the data plane VCN 818 via VNICs 842 that can be contained in the data plane mirror app tier 840 and the data plane app tier 846.

In some examples, users of the system, or customers, can make requests, for example create, read, update, or delete (CRUD) operations, through public Internet 854 that can communicate the requests to the metadata management service 852. The metadata management service 852 can communicate the request to the control plane VCN 816 through the Internet gateway 834. The request can be received by the LB subnet(s) 822 contained in the control plane DMZ tier 820. The LB subnet(s) 822 may determine that the request is valid, and in response to this determination, the LB subnet(s) 822 can transmit the request to app subnet(s) 826 contained in the control plane app tier 824. If the request is validated and requires a call to public Internet 854, the call to public Internet 854 may be transmitted to the NAT gateway 838 that can make the call to public Internet 854. Metadata that may be desired to be stored by the request can be stored in the DB subnet(s) 830.

In some examples, the data plane mirror app tier 840 can facilitate direct communication between the control plane VCN 816 and the data plane VCN 818. For example, changes, updates, or other suitable modifications to configuration may be desired to be applied to the resources contained in the data plane VCN 818. Via a VNIC 842, the control plane VCN 816 can directly communicate with, and can thereby execute the changes, updates, or other suitable modifications to configuration to, resources contained in the data plane VCN 818.

In some embodiments, the control plane VCN 816 and the data plane VCN 818 can be contained in the service tenancy 819. In this case, the user, or the customer, of the system may not own or operate either the control plane VCN 816 or the data plane VCN 818. Instead, the IaaS provider may own or operate the control plane VCN 816 and the data plane VCN 818, both of which may be contained in the service tenancy 819. This embodiment can enable isolation of networks that may prevent users or customers from interacting with other users', or other customers', resources. Also, this embodiment may allow users or customers of the system to store databases privately without needing to rely on public Internet 854, which may not have a desired level of threat prevention, for storage.

In other embodiments, the LB subnet(s) 822 contained in the control plane VCN 816 can be configured to receive a signal from the service gateway 836. In this embodiment, the control plane VCN 816 and the data plane VCN 818 may be configured to be called by a customer of the IaaS provider without calling public Internet 854. Customers of the IaaS provider may desire this embodiment since database(s) that the customers use may be controlled by the IaaS provider and may be stored on the service tenancy 819, which may be isolated from public Internet 854.

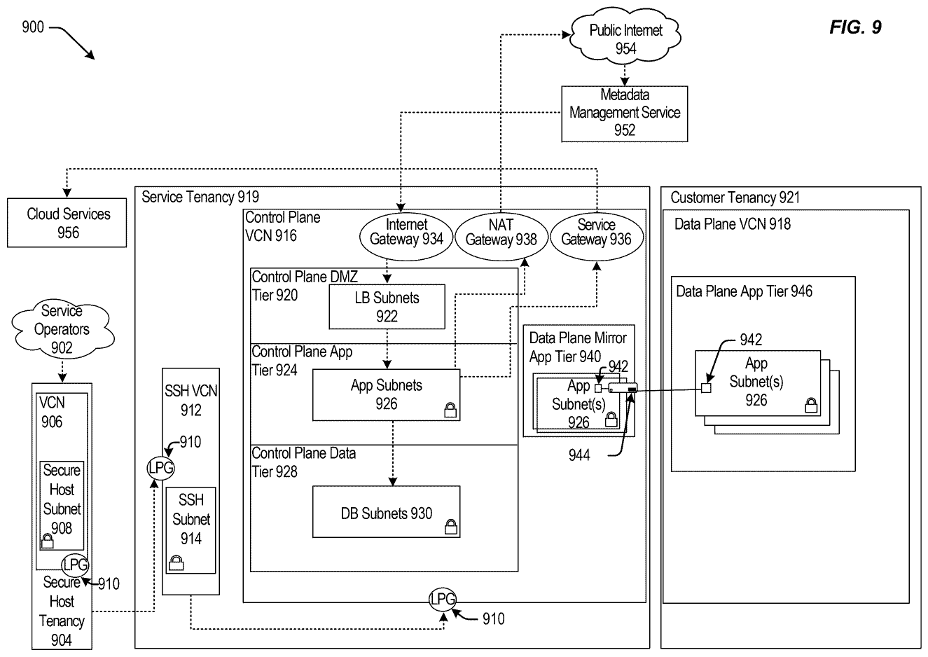

FIG. 9 is a block diagram 900 illustrating another example pattern of an IaaS architecture, according to at least one embodiment. Service operators 902 (e.g., service operators 802 of FIG. 8) can be communicatively coupled to a secure host tenancy 904 (e.g., the secure host tenancy 804 of FIG. 8) that can include a virtual cloud network (VCN) 906 (e.g., the VCN 806 of FIG. 8) and a secure host subnet 908 (e.g., the secure host subnet 808 of FIG. 8). The VCN 906 can include a local peering gateway (LPG) 910 (e.g., the LPG 810 of FIG. 8) that can be communicatively coupled to a secure shell (SSH) VCN 912 (e.g., the SSH VCN 812 of FIG. 8) via an LPG 810 contained in the SSH VCN 912. The SSH VCN 912 can include an SSH subnet 914 (e.g., the SSH subnet 814 of FIG. 8), and the SSH VCN 912 can be communicatively coupled to a control plane VCN 916 (e.g., the control plane VCN 816 of FIG. 8) via an LPG 910 contained in the control plane VCN 916. The control plane VCN 916 can be contained in a service tenancy 919 (e.g., the service tenancy 819 of FIG. 8), and the data plane VCN 918 (e.g., the data plane VCN 818 of FIG. 8) can be contained in a customer tenancy 921 that may be owned or operated by users, or customers, of the system.

The control plane VCN 916 can include a control plane DMZ tier 920 (e.g., the control plane DMZ tier 820 of FIG. 8) that can include LB subnet(s) 922 (e.g., LB subnet(s) 822 of FIG. 8), a control plane app tier 924 (e.g., the control plane app tier 824 of FIG. 8) that can include app subnet(s) 926 (e.g., app subnet(s) 826 of FIG. 8), a control plane data tier 928 (e.g., the control plane data tier 828 of FIG. 8) that can include database (DB) subnet(s) 930 (e.g., similar to DB subnet(s) 830 of FIG. 8). The LB subnet(s) 922 contained in the control plane DMZ tier 920 can be communicatively coupled to the app subnet(s) 926 contained in the control plane app tier 924 and an Internet gateway 934 (e.g., the Internet gateway 834 of FIG. 8) that can be contained in the control plane VCN 916, and the app subnet(s) 926 can be communicatively coupled to the DB subnet(s) 930 contained in the control plane data tier 928 and a service gateway 936 (e.g., the service gateway 836 of FIG. 8) and a network address translation (NAT) gateway 938 (e.g., the NAT gateway 838 of FIG. 8). The control plane VCN 916 can include the service gateway 936 and the NAT gateway 938.

The control plane VCN 916 can include a data plane mirror app tier 940 (e.g., the data plane mirror app tier 840 of FIG. 8) that can include app subnet(s) 926. The app subnet(s) 926 contained in the data plane mirror app tier 940 can include a virtual network interface controller (VNIC) 942 (e.g., the VNIC of 842) that can execute a compute instance 944 (e.g., similar to the compute instance 844 of FIG. 8). The compute instance 944 can facilitate communication between the app subnet(s) 926 of the data plane mirror app tier 940 and the app subnet(s) 926 that can be contained in a data plane app tier 946 (e.g., the data plane app tier 846 of FIG. 8) via the VNIC 942 contained in the data plane mirror app tier 940 and the VNIC 942 contained in the data plane app tier 946.

The Internet gateway 934 contained in the control plane VCN 916 can be communicatively coupled to a metadata management service 952 (e.g., the metadata management service 852 of FIG. 8) that can be communicatively coupled to public Internet 954 (e.g., public Internet 854 of FIG. 8). Public Internet 954 can be communicatively coupled to the NAT gateway 938 contained in the control plane VCN 916. The service gateway 936 contained in the control plane VCN 916 can be communicatively coupled to cloud services 956 (e.g., cloud services 856 of FIG. 8).

In some examples, the data plane VCN 918 can be contained in the customer tenancy 921. In this case, the IaaS provider may provide the control plane VCN 916 for each customer, and the IaaS provider may, for each customer, set up a unique compute instance 944 that is contained in the service tenancy 919. Each compute instance 944 may allow communication between the control plane VCN 916, contained in the service tenancy 919, and the data plane VCN 918 that is contained in the customer tenancy 921. The compute instance 944 may allow resources, that are provisioned in the control plane VCN 916 that is contained in the service tenancy 919, to be deployed or otherwise used in the data plane VCN 918 that is contained in the customer tenancy 921.

In other examples, the customer of the IaaS provider may have databases that live in the customer tenancy 921. In this example, the control plane VCN 916 can include the data plane mirror app tier 940 that can include app subnet(s) 926. The data plane mirror app tier 940 can reside in the data plane VCN 918, but the data plane mirror app tier 940 may not live in the data plane VCN 918. That is, the data plane mirror app tier 940 may have access to the customer tenancy 921, but the data plane mirror app tier 940 may not exist in the data plane VCN 918 or be owned or operated by the customer of the IaaS provider. The data plane mirror app tier 940 may be configured to make calls to the data plane VCN 918 but may not be configured to make calls to any entity contained in the control plane VCN 916. The customer may desire to deploy or otherwise use resources in the data plane VCN 918 that are provisioned in the control plane VCN 916, and the data plane mirror app tier 940 can facilitate the desired deployment, or other usage of resources, of the customer.

In some embodiments, the customer of the IaaS provider can apply filters to the data plane VCN 918. In this embodiment, the customer can determine what the data plane VCN 918 can access, and the customer may restrict access to public Internet 954 from the data plane VCN 918. The IaaS provider may not be able to apply filters or otherwise control access of the data plane VCN 918 to any outside networks or databases. Applying filters and controls by the customer onto the data plane VCN 918, contained in the customer tenancy 921, can help isolate the data plane VCN 918 from other customers and from public Internet 954.

In some embodiments, cloud services 956 can be called by the service gateway 936 to access services that may not exist on public Internet 954, on the control plane VCN 916, or on the data plane VCN 918. The connection between cloud services 956 and the control plane VCN 916 or the data plane VCN 918 may not be live or continuous. Cloud services 956 may exist on a different network owned or operated by the IaaS provider. Cloud services 956 may be configured to receive calls from the service gateway 936 and may be configured to not receive calls from public Internet 954. Some cloud services 956 may be isolated from other cloud services 956, and the control plane VCN 916 may be isolated from cloud services 956 that may not be in the same region as the control plane VCN 916. For example, the control plane VCN 916 may be located in “Region 1,” and cloud service “Deployment 8,” may be located in Region 1 and in “Region 2.” If a call to Deployment 8 is made by the service gateway 936 contained in the control plane VCN 916 located in Region 1, the call may be transmitted to Deployment 8 in Region 1. In this example, the control plane VCN 916, or Deployment 8 in Region 1, may not be communicatively coupled to, or otherwise in communication with, Deployment 8 in Region 2.

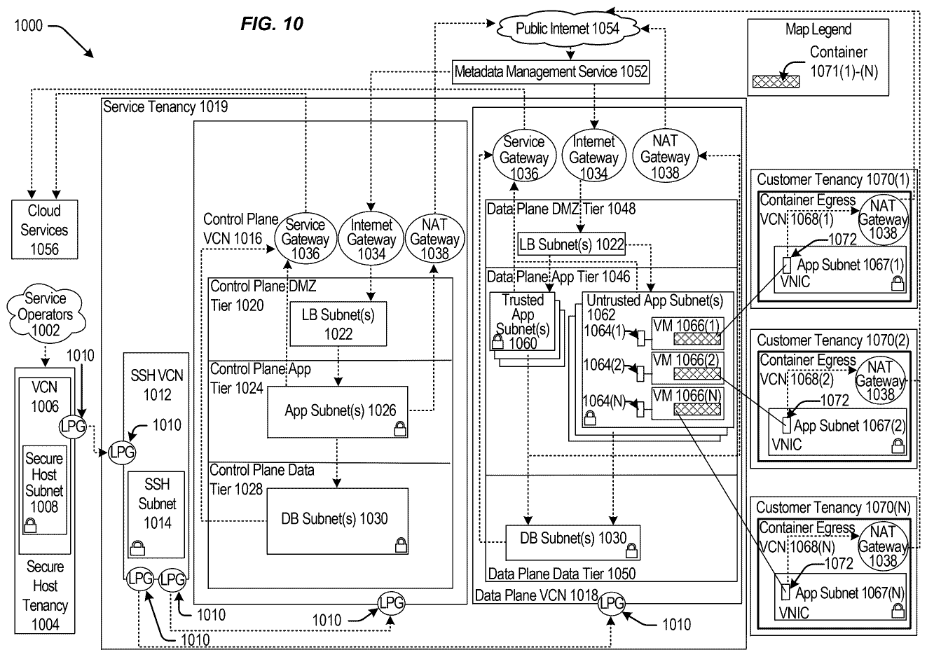

FIG. 10 is a block diagram 1000 illustrating another example pattern of an IaaS architecture, according to at least one embodiment. Service operators 1002 (e.g., service operators 802 of FIG. 8) can be communicatively coupled to a secure host tenancy 1004 (e.g., the secure host tenancy 804 of FIG. 8) that can include a virtual cloud network (VCN) 1006 (e.g., the VCN 806 of FIG. 8) and a secure host subnet 1008 (e.g., the secure host subnet 808 of FIG. 8). The VCN 1006 can include an LPG 1010 (e.g., the LPG 810 of FIG. 8) that can be communicatively coupled to an SSH VCN 1012 (e.g., the SSH VCN 812 of FIG. 8) via an LPG 1010 contained in the SSH VCN 1012. The SSH VCN 1012 can include an SSH subnet 1014 (e.g., the SSH subnet 814 of FIG. 8), and the SSH VCN 1012 can be communicatively coupled to a control plane VCN 1016 (e.g., the control plane VCN 816 of FIG. 8) via an LPG 1010 contained in the control plane VCN 1016 and to a data plane VCN 1018 (e.g., the data plane 818 of FIG. 8) via an LPG 1010 contained in the data plane VCN 1018. The control plane VCN 1016 and the data plane VCN 1018 can be contained in a service tenancy 1019 (e.g., the service tenancy 819 of FIG. 8).

The control plane VCN 1016 can include a control plane DMZ tier 1020 (e.g., the control plane DMZ tier 820 of FIG. 8) that can include load balancer (LB) subnet(s) 1022 (e.g., LB subnet(s) 822 of FIG. 8), a control plane app tier 1024 (e.g., the control plane app tier 824 of FIG. 8) that can include app subnet(s) 1026 (e.g., similar to app subnet(s) 826 of FIG. 8), a control plane data tier 1028 (e.g., the control plane data tier 828 of FIG. 8) that can include DB subnet(s) 1030. The LB subnet(s) 1022 contained in the control plane DMZ tier 1020 can be communicatively coupled to the app subnet(s) 1026 contained in the control plane app tier 1024 and to an Internet gateway 1034 (e.g., the Internet gateway 834 of FIG. 8) that can be contained in the control plane VCN 1016, and the app subnet(s) 1026 can be communicatively coupled to the DB subnet(s) 1030 contained in the control plane data tier 1028 and to a service gateway 1036 (e.g., the service gateway of FIG. 8) and a network address translation (NAT) gateway 1038 (e.g., the NAT gateway 838 of FIG. 8). The control plane VCN 1016 can include the service gateway 1036 and the NAT gateway 1038.

The data plane VCN 1018 can include a data plane app tier 1046 (e.g., the data plane app tier 846 of FIG. 8), a data plane DMZ tier 1048 (e.g., the data plane DMZ tier 848 of FIG. 8), and a data plane data tier 1050 (e.g., the data plane data tier 850 of FIG. 8). The data plane DMZ tier 1048 can include LB subnet(s) 1022 that can be communicatively coupled to trusted app subnet(s) 1060 and untrusted app subnet(s) 1062 of the data plane app tier 1046 and the Internet gateway 1034 contained in the data plane VCN 1018. The trusted app subnet(s) 1060 can be communicatively coupled to the service gateway 1036 contained in the data plane VCN 1018, the NAT gateway 1038 contained in the data plane VCN 1018, and DB subnet(s) 1030 contained in the data plane data tier 1050. The untrusted app subnet(s) 1062 can be communicatively coupled to the service gateway 1036 contained in the data plane VCN 1018 and DB subnet(s) 1030 contained in the data plane data tier 1050. The data plane data tier 1050 can include DB subnet(s) 1030 that can be communicatively coupled to the service gateway 1036 contained in the data plane VCN 1018.

The untrusted app subnet(s) 1062 can include one or more primary VNICs 1064(1)-(N) that can be communicatively coupled to tenant virtual machines (VMs) 1066(1)-(N). Each tenant VM 1066(1)-(N) can be communicatively coupled to a respective app subnet 1067(1)-(N) that can be contained in respective container egress VCNs 1068(1)-(N) that can be contained in respective customer tenancies 1070(1)-(N). Respective secondary VNICs 1072(1)-(N) can facilitate communication between the untrusted app subnet(s) 1062 contained in the data plane VCN 1018 and the app subnet contained in the container egress VCNs 1068(1)-(N). Each container egress VCNs 1068(1)-(N) can include a NAT gateway 1038 that can be communicatively coupled to public Internet 1054 (e.g., public Internet 854 of FIG. 8).

The Internet gateway 1034 contained in the control plane VCN 1016 and contained in the data plane VCN 1018 can be communicatively coupled to a metadata management service 1052 (e.g., the metadata management system 852 of FIG. 8) that can be communicatively coupled to public Internet 1054. Public Internet 1054 can be communicatively coupled to the NAT gateway 1038 contained in the control plane VCN 1016 and contained in the data plane VCN 1018. The service gateway 1036 contained in the control plane VCN 1016 and contained in the data plane VCN 1018 can be communicatively coupled to cloud services 1056.

In some embodiments, the data plane VCN 1018 can be integrated with customer tenancies 1070. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1046. Code to run the function may be executed in the VMs 1066(1)-(N), and the code may not be configured to run anywhere else on the data plane VCN 1018. Each VM 1066(1)-(N) may be connected to one customer tenancy 1070. Respective containers 1071(1)-(N) contained in the VMs 1066(1)-(N) may be configured to run the code. In this case, there can be a dual isolation (e.g., the containers 1071(1)-(N) running code, where the containers 1071(1)-(N) may be contained in at least the VM 1066(1)-(N) that are contained in the untrusted app subnet(s) 1062), which may help prevent incorrect or otherwise undesirable code from damaging the network of the IaaS provider or from damaging a network of a different customer. The containers 1071(1)-(N) may be communicatively coupled to the customer tenancy 1070 and may be configured to transmit or receive data from the customer tenancy 1070. The containers 1071(1)-(N) may not be configured to transmit or receive data from any other entity in the data plane VCN 1018. Upon completion of running the code, the IaaS provider may kill or otherwise dispose of the containers 1071(1)-(N).

In some embodiments, the trusted app subnet(s) 1060 may run code that may be owned or operated by the IaaS provider. In this embodiment, the trusted app subnet(s) 1060 may be communicatively coupled to the DB subnet(s) 1030 and be configured to execute CRUD operations in the DB subnet(s) 1030. The untrusted app subnet(s) 1062 may be communicatively coupled to the DB subnet(s) 1030, but in this embodiment, the untrusted app subnet(s) may be configured to execute read operations in the DB subnet(s) 1030. The containers 1071(1)-(N) that can be contained in the VM 1066(1)-(N) of each customer and that may run code from the customer may not be communicatively coupled with the DB subnet(s) 1030.

In other embodiments, the control plane VCN 1016 and the data plane VCN 1018 may not be directly communicatively coupled. In this embodiment, there may be no direct communication between the control plane VCN 1016 and the data plane VCN 1018. However, communication can occur indirectly through at least one method. An LPG 1010 may be established by the IaaS provider that can facilitate communication between the control plane VCN 1016 and the data plane VCN 1018. In another example, the control plane VCN 1016 or the data plane VCN 1018 can make a call to cloud services 1056 via the service gateway 1036. For example, a call to cloud services 1056 from the control plane VCN 1016 can include a request for a service that can communicate with the data plane VCN 1018.

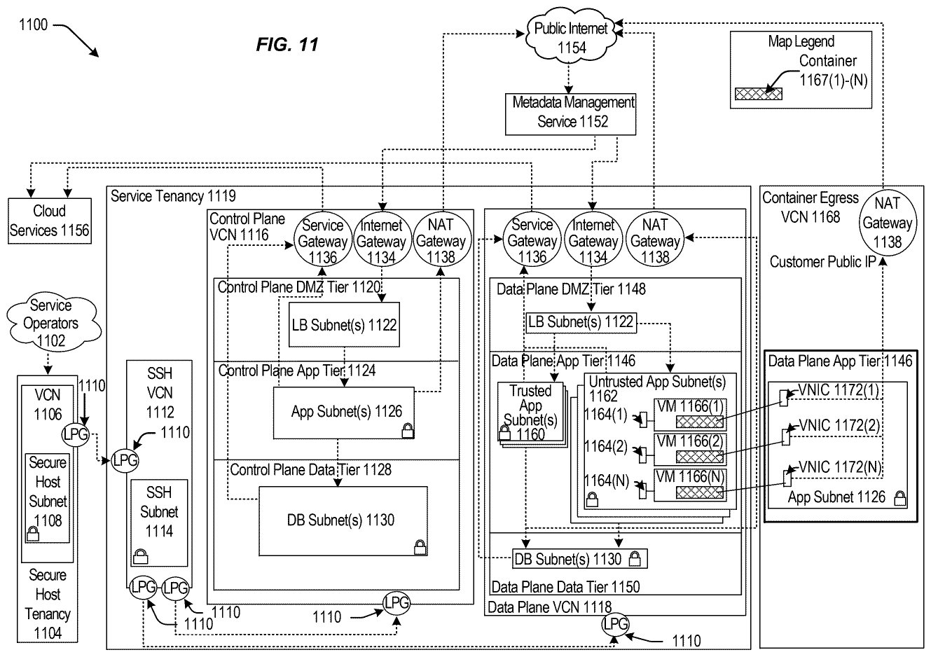

FIG. 11 is a block diagram 1100 illustrating another example pattern of an IaaS architecture, according to at least one embodiment. Service operators 1102 (e.g., service operators 802 of FIG. 8) can be communicatively coupled to a secure host tenancy 1104 (e.g., the secure host tenancy 804 of FIG. 8) that can include a virtual cloud network (VCN) 1106 (e.g., the VCN 806 of FIG. 8) and a secure host subnet 1108 (e.g., the secure host subnet 808 of FIG. 8). The VCN 1106 can include an LPG 1110 (e.g., the LPG 810 of FIG. 8) that can be communicatively coupled to an SSH VCN 1112 (e.g., the SSH VCN 812 of FIG. 8) via an LPG 1110 contained in the SSH VCN 1112. The SSH VCN 1112 can include an SSH subnet 1114 (e.g., the SSH subnet 814 of FIG. 8), and the SSH VCN 1112 can be communicatively coupled to a control plane VCN 1116 (e.g., the control plane VCN 816 of FIG. 8) via an LPG 1110 contained in the control plane VCN 1116 and to a data plane VCN 1118 (e.g., the data plane 818 of FIG. 8) via an LPG 1110 contained in the data plane VCN 1118. The control plane VCN 1116 and the data plane VCN 1118 can be contained in a service tenancy 1119 (e.g., the service tenancy 819 of FIG. 8).

The control plane VCN 1116 can include a control plane DMZ tier 1120 (e.g., the control plane DMZ tier 820 of FIG. 8) that can include LB subnet(s) 1122 (e.g., LB subnet(s) 822 of FIG. 8), a control plane app tier 1124 (e.g., the control plane app tier 824 of FIG. 8) that can include app subnet(s) 1126 (e.g., app subnet(s) 826 of FIG. 8), a control plane data tier 1128 (e.g., the control plane data tier 828 of FIG. 8) that can include DB subnet(s) 1130 (e.g., DB subnet(s) 1030 of FIG. 10). The LB subnet(s) 1122 contained in the control plane DMZ tier 1120 can be communicatively coupled to the app subnet(s) 1126 contained in the control plane app tier 1124 and to an Internet gateway 1134 (e.g., the Internet gateway 834 of FIG. 8) that can be contained in the control plane VCN 1116, and the app subnet(s) 1126 can be communicatively coupled to the DB subnet(s) 1130 contained in the control plane data tier 1128 and to a service gateway 1136 (e.g., the service gateway of FIG. 8) and a network address translation (NAT) gateway 1138 (e.g., the NAT gateway 838 of FIG. 8). The control plane VCN 1116 can include the service gateway 1136 and the NAT gateway 1138.

The data plane VCN 1118 can include a data plane app tier 1146 (e.g., the data plane app tier 846 of FIG. 8), a data plane DMZ tier 1148 (e.g., the data plane DMZ tier 848 of FIG. 8), and a data plane data tier 1150 (e.g., the data plane data tier 850 of FIG. 8). The data plane DMZ tier 1148 can include LB subnet(s) 1122 that can be communicatively coupled to trusted app subnet(s) 1160 (e.g., trusted app subnet(s) 1060 of FIG. 10) and untrusted app subnet(s) 1162 (e.g., untrusted app subnet(s) 1062 of FIG. 10) of the data plane app tier 1146 and the Internet gateway 1134 contained in the data plane VCN 1118. The trusted app subnet(s) 1160 can be communicatively coupled to the service gateway 1136 contained in the data plane VCN 1118, the NAT gateway 1138 contained in the data plane VCN 1118, and DB subnet(s) 1130 contained in the data plane data tier 1150. The untrusted app subnet(s) 1162 can be communicatively coupled to the service gateway 1136 contained in the data plane VCN 1118 and DB subnet(s) 1130 contained in the data plane data tier 1150. The data plane data tier 1150 can include DB subnet(s) 1130 that can be communicatively coupled to the service gateway 1136 contained in the data plane VCN 1118.

The untrusted app subnet(s) 1162 can include primary VNICs 1164(1)-(N) that can be communicatively coupled to tenant virtual machines (VMs) 1166(1)-(N) residing within the untrusted app subnet(s) 1162. Each tenant VM 1166(1)-(N) can run code in a respective container 1167(1)-(N), and be communicatively coupled to an app subnet 1126 that can be contained in a data plane app tier 1146 that can be contained in a container egress VCN 1168. Respective secondary VNICs 1172(1)-(N) can facilitate communication between the untrusted app subnet(s) 1162 contained in the data plane VCN 1118 and the app subnet contained in the container egress VCN 1168. The container egress VCN can include a NAT gateway 1138 that can be communicatively coupled to public Internet 1154 (e.g., public Internet 854 of FIG. 8).

The Internet gateway 1134 contained in the control plane VCN 1116 and contained in the data plane VCN 1118 can be communicatively coupled to a metadata management service 1152 (e.g., the metadata management system 852 of FIG. 8) that can be communicatively coupled to public Internet 1154. Public Internet 1154 can be communicatively coupled to the NAT gateway 1138 contained in the control plane VCN 1116 and contained in the data plane VCN 1118. The service gateway 1136 contained in the control plane VCN 1116 and contained in the data plane VCN 1118 can be communicatively coupled to cloud services 1156.

In some examples, the pattern illustrated by the architecture of block diagram 1100 of FIG. 11 may be considered an exception to the pattern illustrated by the architecture of block diagram 1000 of FIG. 10 and may be desirable for a customer of the IaaS provider if the IaaS provider cannot directly communicate with the customer (e.g., a disconnected region). The respective containers 1167(1)-(N) that are contained in the VMs 1166(1)-(N) for each customer can be accessed in real-time by the customer. The containers 1167(1)-(N) may be configured to make calls to respective secondary VNICs 1172(1)-(N) contained in app subnet(s) 1126 of the data plane app tier 1146 that can be contained in the container egress VCN 1168. The secondary VNICs 1172(1)-(N) can transmit the calls to the NAT gateway 1138 that may transmit the calls to public Internet 1154. In this example, the containers 1167(1)-(N) that can be accessed in real-time by the customer can be isolated from the control plane VCN 1116 and can be isolated from other entities contained in the data plane VCN 1118. The containers 1167(1)-(N) may also be isolated from resources from other customers.

In other examples, the customer can use the containers 1167(1)-(N) to call cloud services 1156. In this example, the customer may run code in the containers 1167(1)-(N) that requests a service from cloud services 1156. The containers 1167(1)-(N) can transmit this request to the secondary VNICs 1172(1)-(N) that can transmit the request to the NAT gateway that can transmit the request to public Internet 1154. Public Internet 1154 can transmit the request to LB subnet(s) 1122 contained in the control plane VCN 1116 via the Internet gateway 1134. In response to determining the request is valid, the LB subnet(s) can transmit the request to app subnet(s) 1126 that can transmit the request to cloud services 1156 via the service gateway 1136.

It should be appreciated that IaaS architectures 800, 900, 1000, 1100 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

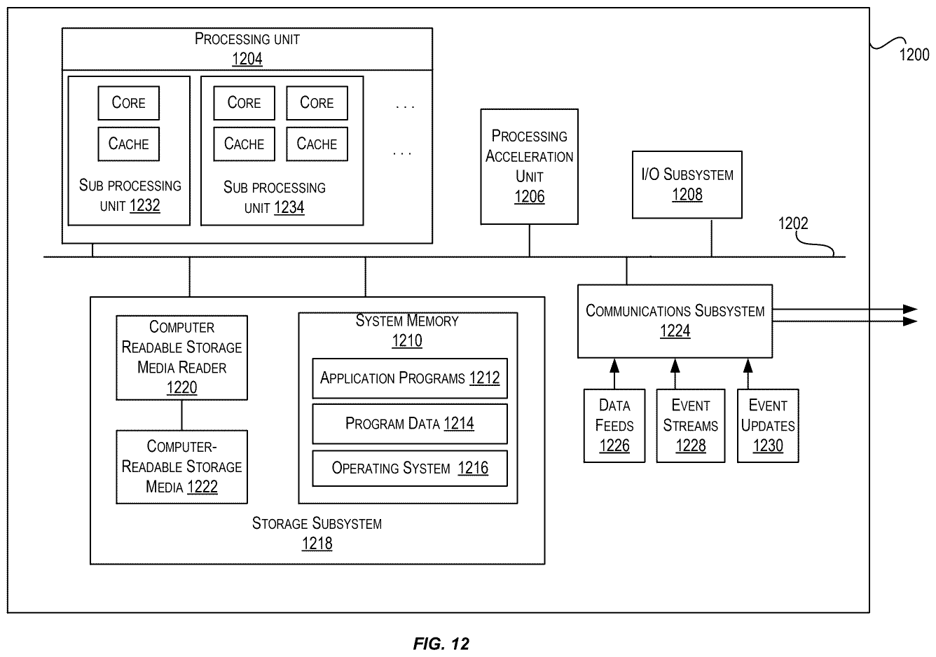

FIG. 12 illustrates an example computer system 1200, in which various embodiments may be implemented. The system 1200 may be used to implement any of the computer systems described above. As shown in the figure, computer system 1200 includes a processing unit 1204 that communicates with a number of peripheral subsystems via a bus subsystem 1202. These peripheral subsystems may include a processing acceleration unit 1206, an I/O subsystem 1208, a storage subsystem 1218 and a communications subsystem 1224. Storage subsystem 1218 includes tangible computer-readable storage media 1222 and a system memory 1210.

Bus subsystem 1202 provides a mechanism for letting the various components and subsystems of computer system 1200 communicate with each other as intended. Although bus subsystem 1202 is shown schematically as a single bus, alternative embodiments of the bus subsystem may utilize multiple buses. Bus subsystem 1202 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1204, which can be implemented as one or more integrated circuits (e.g., a conventional microprocessor or microcontroller), controls the operation of computer system 1200. One or more processors may be included in processing unit 1204. These processors may include single core or multicore processors. In certain embodiments, processing unit 1204 may be implemented as one or more independent processing units 1232 and/or 1234 with single or multicore processors included in each processing unit. In other embodiments, processing unit 1204 may also be implemented as a quad-core processing unit formed by integrating two dual-core processors into a single chip.

In various embodiments, processing unit 1204 can execute a variety of programs in response to program code and can maintain multiple concurrently executing programs or processes. At any given time, some or all of the program code to be executed can be resident in processor(s) 1204 and/or in storage subsystem 1218. Through suitable programming, processor(s) 1204 can provide various functionalities described above. Computer system 1200 may additionally include a processing acceleration unit 1206, which can include a digital signal processor (DSP), a special-purpose processor, and/or the like.

I/O subsystem 1208 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1200 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1200 may comprise a storage subsystem 1218 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1204 provide the functionality described above. Storage subsystem 1218 may also provide a repository for storing data used in accordance with the present disclosure.

As depicted in the example in FIG. 12, storage subsystem 1218 can include various components including a system memory 1210, computer-readable storage media 1222, and a computer readable storage media reader 1220. System memory 1210 may store program instructions that are loadable and executable by processing unit 1204. System memory 1210 may also store data that is used during the execution of the instructions and/or data that is generated during the execution of the program instructions. Various different kinds of programs may be loaded into system memory 1210 including but not limited to client applications, Web browsers, mid-tier applications, relational database management systems (RDBMS), virtual machines, containers, etc.

System memory 1210 may also store an operating system 1216. Examples of operating system 1216 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1200 executes one or more virtual machines, the virtual machines along with their guest operating systems (GOSs) may be loaded into system memory 1210 and executed by one or more processors or cores of processing unit 1204.

System memory 1210 can come in different configurations depending upon the type of computer system 1200. For example, system memory 1210 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1210 may include a basic input/output system (BIOS) containing basic routines that help to transfer information between elements within computer system 1200, such as during start-up.

Computer-readable storage media 1222 may represent remote, local, fixed, and/or removable storage devices plus storage media for temporarily and/or more permanently containing, storing, computer-readable information for use by computer system 1200 including instructions executable by processing unit 1204 of computer system 1200.

Computer-readable storage media 1222 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1222 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1222 may include, but is not limited to, Zip® drives, flash memory cards, universal serial bus (USB) flash drives, secure digital (SD) cards, DVD disks, digital video tape, and the like. Computer-readable storage media 1222 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1200.

Machine-readable instructions executable by one or more processors or cores of processing unit 1204 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1224 provides an interface to other computer systems and networks. Communications subsystem 1224 serves as an interface for receiving data from and transmitting data to other systems from computer system 1200. For example, communications subsystem 1224 may enable computer system 1200 to connect to one or more devices via the Internet. In some embodiments communications subsystem 1224 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1224 can provide wired network connectivity (e.g., Ethernet) in addition to or instead of a wireless interface.

In some embodiments, communications subsystem 1224 may also receive input communication in the form of structured and/or unstructured data feeds 1226, event streams 1228, event updates 1230, and the like on behalf of one or more users who may use computer system 1200.

By way of example, communications subsystem 1224 may be configured to receive data feeds 1226 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1224 may also be configured to receive data in the form of continuous data streams, which may include event streams 1228 of real-time events and/or event updates 1230, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1224 may also be configured to output the structured and/or unstructured data feeds 1226, event streams 1228, event updates 1230, and the like to one or more databases that may be in communication with one or more streaming data source computers coupled to computer system 1200.

Computer system 1200 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1200 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method, comprising:
receiving, by a computing system, a feature vector associated with a detected event, the feature vector including a strong entity indicator and a weak entity indicator;
processing, by a graph model of the computing system, the strong entity indicator to obtain a graph label;
processing, by a machine-learning clustering model of the computing system and post validation process, the weak entity indicator and the graph label to obtain a cluster label for the detected event;
determining, based at least in part on the cluster label, a score associated with the detected event; and
generating, based at least in part on the score, a notification message to be stored or sent to a user interface.

2. The computer-implemented method of claim 1, wherein the graph model includes one or more disjoint graphs, each graph of the one or more disjoint graphs is associated with a label, and wherein the processing, by the graph model, of the strong entity indicator to obtain a graph label comprises:
identifying a graph of the one or more disjoint graphs associated with the strong entity indicator; and
identifying a label associated with the graph.

3. The computer-implemented method of claim 1, wherein the feature vector is a first feature vector, and the post validation process comprises:
identifying, based at least in part by the machine-learning clustering model, a first cluster of feature vector; and
determining a second cluster that is a subset of the first cluster, wherein each second feature vector of the second cluster satisfies a condition that a distance between the second feature vector and the first feature vector is less than a distance threshold.

4. The computer-implemented method of claim 1, further comprising:
receiving a record associated with the detected event; and
processing the record to obtain the feature vector.

5. The computer-implemented method of claim 1, wherein the feature vector is a first feature vector, and the method further comprises:
identifying a cluster including a second feature vector;
determining that a common feature exists between the first feature vector and the second feature vector; and
clustering the second feature vector with the first feature vector.

6. The computer-implemented method of claim 1, wherein the feature vector is a first feature vector, and the method further comprises:
determining, by the graph model, a first graph associated with the first feature vector;
determining, by the graph model, a second graph associated with a second feature vector; and
determining whether the first graph and the second graph are disjoint.

7. The computer-implemented method of claim 6, wherein said determining whether the first graph and the second graph are disjoint comprises determining that the first graph and the second graph are not disjoint, and the method further comprises:
clustering the first feature vector and the second feature vector in a same cluster.

8. A computing device comprising:
a memory configured to store computer-executable instructions; and
one or more processors configured to access the memory and execute the computer-executable instructions to:
receive a feature vector associated with a detected event, the feature vector including a strong entity indicator and a weak entity indicator;
process the strong entity indicator to obtain a graph label associated with a graph model;
process the weak entity indicator and the graph label to obtain a cluster label for the detected event;
determine, based at least in part on the cluster label, a score associated with the detected event; and
generating, based at least in part on the score, a notification message to be stored or sent to a user interface.

9. The computing device of claim 8, wherein the graph model includes one or more disjoint graphs, each graph of the one or more disjoint graphs is associated with a label, and to process the strong entity indicator to obtain a graph label the processor is further to:
identify a graph of the one or more disjoint graphs associated with the strong entity indicator; and
identify a label associated with the graph.

10. The computing device of claim 8, wherein the feature vector is a first feature vector, and the processor is further to:
identify, based at least in part on the cluster label, a first cluster of feature vector; and
determine a second cluster that is a subset of the first cluster, wherein each second feature vector of the second cluster satisfies a condition that a distance between the second feature vector and the first feature vector is less than a distance threshold.

11. The computing device of claim 8, wherein the processor is further to:
receive a record associated with the detected event; and
process the record to obtain the feature vector.

12. The computing device of claim 8, wherein the feature vector is a first feature vector, and the processor is further to:
identify a cluster including a second feature vector;
determine that a common feature exists between the first feature vector and the second feature vector; and
cluster the second feature vector with the first feature vector.

13. The computing device of claim 8, wherein the feature vector is a first feature vector, and the processor is further to:
determine a first graph associated with the first feature vector;
determine a second graph associated with a second feature vector; and
determine whether the first graph and the second graph are disjoint.

14. The computing device of claim 13, wherein to determine whether the first graph and the second graph are disjoint the processor is further to:
determine that the first graph and the second graph are not disjoint; and
clustering the first feature vector and the second feature vector in a same cluster.

15. A non-transitory computer-readable medium configured to store computer-executable instructions that, when executed, cause one or more processors of a computing system to perform operations comprising:
receiving a feature vector associated with a detected event, the feature vector including a strong entity indicator and a weak entity indicator;
processing the strong entity indicator to obtain a graph label associated with a graph model;
processing the weak entity indicator and the graph label to obtain a cluster label for the detected event;
determining, based at least in part on the cluster label, a score associated with the detected event; and
generating, based at least in part on the score, a notification message to be stored or sent to a user interface.

16. The non-transitory computer-readable medium of claim 15, wherein the graph model includes one or more disjoint graphs, each graph of the one or more disjoint graphs is associated with a label, and to process the strong entity indicator to obtain a graph label, the instructions when executed, further cause the one or more processors to perform additional operations comprising:
identifying a graph of the one or more disjoint graphs associated with the strong entity indicator; and
identifying a label associated with the graph.

17. The non-transitory computer-readable medium of claim 15, wherein the feature vector is a first feature vector, and the instructions when executed, further cause the one or more processors to perform additional operations comprising:
identifying, based at least in part on the cluster label, a first cluster of feature vector; and
determining a second cluster that is a subset of the first cluster, wherein each second feature vector of the second cluster satisfies a condition that a distance between the second feature vector and the first feature vector is less than a distance threshold.

18. The non-transitory computer-readable medium of claim 15, wherein the instructions when executed, cause the one or more processors to perform additional operations comprising:
receiving a record associated with the detected event; and
processing the record to obtain the feature vector.

19. The non-transitory computer-readable medium of claim 15, wherein the feature vector is a first feature vector, and the instructions when executed, further cause the one or more processors to perform additional operations comprising:
identify a cluster including a second feature vector;
determine that a common feature exists between the first feature vector and the second feature vector; and
cluster the second feature vector with the first feature vector.

20. The non-transitory computer-readable medium of claim 15, wherein the feature vector is a first feature vector, and the instructions when executed, further cause the one or more processors to:
determine, by the graph model, a first graph associated with the first feature vector;
determine, by the graph model, a second graph associated with a second feature vector;
determine that the first graph and the second graph are not disjoint; and
clustering the first feature vector and the second feature vector in a same cluster based at least in part on determination that the first graph and the second graph are not disjoint.
